(19) United States
(12) Patent Application Publication
(10) Pub. No.: US 2025/0138582 A1
(43) Pub. Date: May 1, 2025

(54) AUXILIARY APPARATUS FOR ELECTRONIC DEVICE AND SYSTEM OF ELECTRONIC DEVICES

(71) Applicant: Lenovo (Beijing) Limited, Beijing (CN)

(72) Inventors: Xiao HAN, Beijing (CN); Yangtao KANG, Beijing (CN); Renjun GU, Beijing (CN)

(21) Appl. No.: 18/931,289

(22) Filed: Oct. 30, 2024

(30) Foreign Application Priority Data
Oct. 30, 2023 (CN) 202311418596.2

(51) Int. Cl. G06F 1/16

(52) U.S. Cl. CPC G06F 1/162; G06F 1/1654; G06F 1/1669

(57) ABSTRACT

An auxiliary apparatus for an electronic device includes a first body and a second body. The second body includes a first support member and a second support member that are rotatably connected. The first support member is rotatably connected to the first body. The second support member is able to rotate in a direction facing the first body to abut against the first body to allow the first support member and the second support member to be in a first attitude snapping toward the first body to support the electronic device carried by the second support member.

### CROSS REFERENCE TO RELATED APPLICATION

The present disclosure claims priority to Chinese Patent Application No. 202311418596.2, filed on Oct. 30, 2023, the entire content of which is incorporated herein by reference.

### TECHNICAL FIELD

The present disclosure is related to the electronic device technology field and, more particularly, to an auxiliary apparatus for an electronic device and a system of electronic devices.

### BACKGROUND

Tablet computer products typically use external keyboards to enable keyboard operations. Some existing external keyboards are relatively complex, making folding operations inconvenient, and causing the products to be heavy and costly. Some other external keyboards fold backward for support and have limited support methods, which causes poor user experience.

### SUMMARY

An aspect of the present disclosure provides an auxiliary apparatus for an electronic device including a first body and a second body. The second body includes a first support member and a second support member rotatably connected to each other. The first support member is rotatably connected to the first body. The second support member is able to rotate in a direction facing the first body to abut against the first body to allow the first support member and the second support member to be in a first attitude snapping toward the first body to support the electronic device carried by the second support member.

An aspect of the present disclosure provides a system of electronic devices including an electronic device and an auxiliary apparatus for the electronic device. The auxiliary apparatus includes a first body and a second body. The second body includes a first support member and a second support member rotatably connected to each other. The first support member is rotatably connected to the first body. The second support member is able to rotate in a direction facing the first body to abut against the first body to allow the first support member and the second support member to be in a first attitude snapping toward the first body to support the electronic device carried by the second support member.

### BRIEF DESCRIPTION OF THE DRAWINGS

FIG. 1 illustrates a schematic exploded diagram of an auxiliary apparatus for an electronic device according to some embodiments of the present disclosure.

FIG. 2 illustrates a schematic structural diagram of an auxiliary apparatus for an electronic device showing a first support member and a second support member being in a first attitude according to some embodiments of the present disclosure.

FIG. 3 illustrates a schematic structural diagram of an auxiliary apparatus for an electronic device showing the electronic device being in a first support attitude according to some embodiments of the present disclosure.

FIG. 4 illustrates a schematic structural diagram of an auxiliary apparatus for an electronic device showing the electronic device being in a second support attitude according to some embodiments of the present disclosure.

FIG. 5 illustrates a schematic structural diagram of an auxiliary apparatus for an electronic device showing a first support member and a second support member being in a second attitude and a display area of the electronic device arranged facing outside according to some embodiments of the present disclosure.

FIG. 6 illustrates a schematic structural diagram of an auxiliary apparatus for an electronic device showing a first support member and a second support member being in a second attitude and a display area of the electronic device arranged facing inside according to some embodiments of the present disclosure.

FIG. 7 illustrates a schematic structural diagram of an auxiliary apparatus for an electronic device showing the electronic device being in a third support attitude according to some embodiments of the present disclosure.

FIG. 8 illustrates a schematic structural diagram showing a first rotation shaft structure of an auxiliary apparatus for an electronic device according to some embodiments of the present disclosure.

FIG. 9 illustrates a schematic structural diagram showing a second rotation shaft structure of an auxiliary apparatus for an electronic device according to some embodiments of the present disclosure.

Reference numerals:

| | | |
|---|---|---|
| 1 First body | 11 Operation area | 12 First non-operation |
| | | area |
| 13 Second non-operation | | 2 Second body |
| area | | |
| 21 First support member | | 22 Second support |
| | | member |
| 3 Electronic device | 4 First rotation shaft | 5 Second rotation shaft |
| | structure | structure |

### DETAILED DESCRIPTION OF THE EMBODIMENTS

To help those skilled in the art better understand the technical solutions of the present disclosure, the present disclosure is described in detail in connection with the accompanying drawings and specific embodiments. Embodiments of the present disclosure are further described in detail in connection with the accompanying drawings and specific embodiments, which do not limit the present disclosure.

The terms “first,” “second,” and similar terms used in the present disclosure do not indicate any order, quantity, or importance but are merely used to distinguish between different components. Terms like “comprising” or “including” are intended to indicate that an element before the terms encompass elements listed after the terms, without excluding the possibility of encompassing other elements. Terms such as “upper,” “lower,” “left,” and “right” are only used to indicate relative position relationships. When the absolute position of the object described changes, the relative position relationship can change correspondingly.

In the present disclosure, when a specific device is described as being located between a first device and a second device, an intermediate device may or may not exist between the specific device and the first device or the second device. When the specific is described to be connected to another device, the specific device can be directly connected to another device without an intermediate device or can be indirectly connected to another device with the intermediate device.

All terms used in the present disclosure (including technical or scientific terms) have the same meaning as commonly understood by those skilled in the art, unless otherwise specifically defined. Terms defined in a general dictionary should be interpreted as having meanings consistent with the context of the relevant technology and not be overly idealized or excessively formal unless expressly defined otherwise herein.

Technologies, methods, and devices that are known to those skilled in the art may not be discussed in detail, but should be considered as a part of the description where applicable.

Embodiments of the present disclosure provide an auxiliary apparatus for an electronic device. The auxiliary apparatus can be configured to provide functions, including but not limited to supporting and support angle adjusting. For a scenario of using an electronic device 3, the auxiliary apparatus for the electronic device can be configured to provide a more comfortable method for users to use the electronic device 3.

In embodiments of the present disclosure, the electronic device 3 can refer to various electronic devices, such as smartphones, tablets, laptops, etc., which are not limited here.

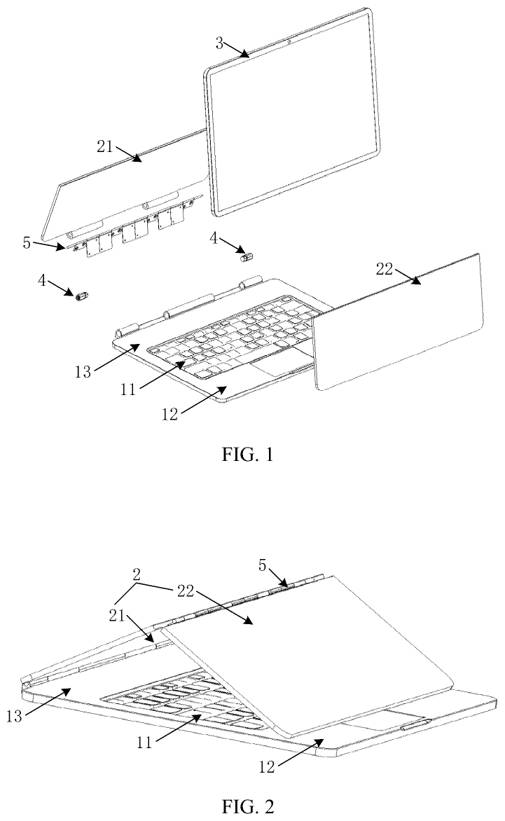

As shown in FIG. 1 to FIG. 7, the auxiliary apparatus of the electronic device includes a first body 1 and a second body 2. The second body 2 includes a first support member 21 and a second support member 22, which are rotatably connected. The first support member 21 is rotatably connected to the first body 1, and the second support member 22 can rotate in a direction facing the first body 1 to abut against the first body 1. Thus, the first support member 21 and the second support member 22 can be in a first attitude of snapping toward the first body to provide support to the electronic device 3 carried by the second support member 22.

As shown in FIG. 2 to FIG. 4, the first support member 21 and the second support member 22 are in the first attitude. The electronic device 3 is placed on the second support member 22. The second support member 22 can be configured to carry the electronic device 3.

In some embodiments, the first body 1 can be configured as an apparatus with a function adapting to the electronic device 3. For example, the first body 1 can have one or more of the following functions, including an input function, a display function, etc.

Exemplarily, the first body 1 can be an input device, such as a physical keyboard or a virtual keyboard. The input device can be communicatively connected to the electronic device 3 to allow the user to operate the input device to input data to the electronic device 3.

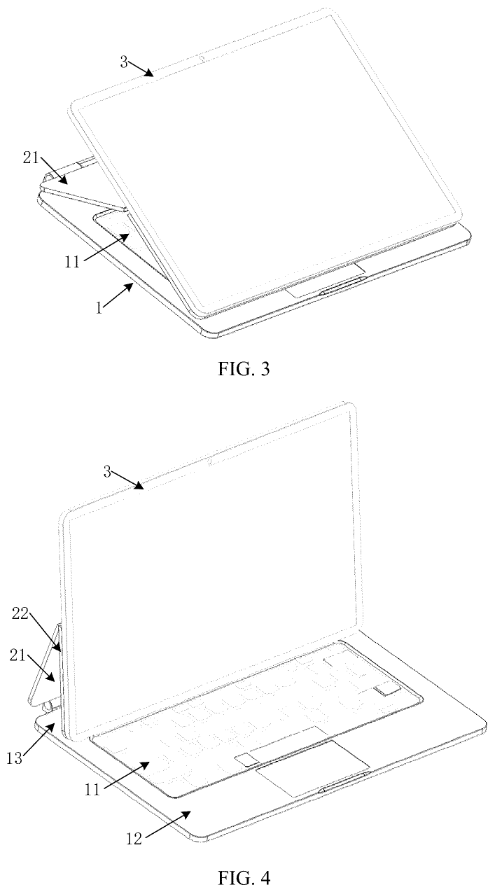

In some embodiments, the auxiliary apparatus for the electronic device can be arranged on an operational platform to provide support for the electronic device 3. The first body 1 can be arranged on the operational platform. In some embodiments, the surface of the first body 1 can be parallel to the operational surface of the operational platform. The second support member 22 can rotate in the direction facing the first body 1. As shown in FIG. 3 and FIG. 4, the second support member 22 is at the position after being rotated in the direction facing the first body 1.

In some embodiments, when the first support member 21 and the second support member 22 are in the first attitude of snapping toward the first body 1, an angle between the plane where the first support member 21 is located and the plane where the second support member 22 is located can range from 0 to 180°.

In some embodiments, the second support member 22 can be configured to carry the electronic device 3. The attitude of the second support member 22 can be adjusted relative to the horizontal plane to adjust the placing attitude of the electronic device 3. Thus, the display area of the electronic device 3 can adapt to the sight of the user to improve the comfort of the user using the electronic device 3.

In some embodiments, the first support member 21 can include a first end and a second end arranged opposite to each other. The first end of the first support member 21 can be rotatably connected to the first body 1, and the second end of the first support member 21 can be rotatably connected to the second support member 22.

In some embodiments, as shown in FIG. 1 and FIG. 8, the first end of the first support member 21 is rotatably connected to the first body 1 via a first rotation shaft structure 4. The first rotation shaft structure 4 can be configured as a damping shaft. Thus, the first support member 21 can rotate to a first predetermined position relative to the first body 1 under a force and can then stably remain at the first predetermined position.

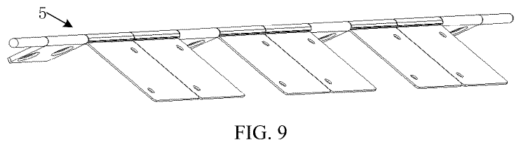

In some embodiments, as shown in FIG. 1, FIG. 2, and FIG. 9, the auxiliary apparatus for the electronic device further includes a second rotation shaft structure 5. The second end of the first support member 21 is rotatably connected to the second support member 22 via the second rotation shaft structure 5. Thus, the first support member 21 and the second support member 22 can rotate relatively to a second predetermined position and then remain stable at the second predetermined position.

In the present disclosure, by rotatably connecting the first body 1 and the second body 2, and by rotatably connecting the first support member 21 and the second support member 22 of the second body 2, the second support member 22 can rotate in the direction facing the first body 1 to abut against the first body 1. Thus, the first support member 21 and the second support member 22 can snap at the first body 1 to stably support the electronic device 3 in the first attitude. The user can conveniently perform the folding operation, and the electronic device 3 can be stably supported. Thus, the display area of the electronic device 3 can adapt to the sight of the user when being supported by the second support member 22, which improves the comfort degree for the user to use the electronic device 3. Moreover, the auxiliary apparatus of the electronic device can have a simple structure and can be easy to carry and move.

In some embodiments, as shown in FIG. 2 to FIG. 4, a surface of the second support member 22 that faces away from the first body 1 is configured as a support surface to carry the electronic device 3. In the first attitude, the first support member 21 and the second support member 22 can snap toward the first body 1 to have a first support angle and a second support angle. Under the first support angle, the second support member 22 can abut against at the first position of the first body 1. Under the second angle, the second support member 22 can abut against at the second position of the first body 1. Corresponding to the first support angle and the second support angle, the first support attitude and the second support attitude can be provided to the carried electronic device 3, respectively. The first support attitude can be different from the second support attitude.

Thus, the user can support the electronic device 3 with the first support member 21 and the second support member 22 having either the first support angle or second support angle depending as needed to satisfy the application requirements of the user for various scenarios. That is, the electronic device 3 can be adjusted to be used in the first support attitude or the second support attitude. As shown in FIG. 3, the electronic device 3 is in the first support attitude. As shown in FIG. 4, the electronic device 3 is in the second support attitude. In the first attitude, the support angle can be relatively large, e.g., 150°, which allows the user to perform an operation such as drawing and can be referred to as a drawing mode. Under the second support attitude, the inclined angle can be relatively small, e.g., 30°, which allows the user to perform office work and can be referred to as an office mode.

In some embodiments, an end of the second support member 22 that is away from the first support member 21 can be configured as a support end. The support end can be configured to abut against the upper surface of the first body 1 at different positions. The support attitude of the electronic device 3 can change as the positions where the support end abuts against the first body 1 changes.

In some embodiments, the first body 1, the first support member 21, and the second support member 22 can be constructed as flat surfaces, which can be enclosed to form a support chamber in a triangular shape. The electronic device 3 can be carried on a wall of the support chamber to stably support the electronic device 3. The first support angle and the second support angle can be understood as internal angles of the support chamber.

In some embodiments, as shown in FIG. 2 and FIG. 3, the first body 1 includes an operation area 11 and a first non-operation area 12. The first non-operation area is farther away from the connection between the first body 1 and the second body 2 compared to the operation area. The first position can be located in the first non-operation area 12.

Thus, when the second support member 22 abuts against the first non-operation area 12 of the first body 1, the first support angle can be configured as an obtuse angle. Thus, the electronic device 3 can be placed at the operation platform in the first support attitude having an angle with the horizontal surface being an acute angle. Then, the user can easily perform operations such as writing and drawing on the electronic device 3, i.e., realizing the drawing mode.

In some embodiments, the first position can be located in different positions within the first non-operation area 12. By adjusting the first position, the first support member 21 and the second support member 22 can be adjusted to form the first support angle snapping toward the first body 1. The first support angle can increase as the first position moves away from the operation area 11 within the first non-operation area 12.

In some embodiments, as shown in FIG. 4, the first body 1 includes an operation area 11 and a second non-operation area 13. The second non-operation area is closer to the connection between the first body 1 and the second body 2 compared to the operation area. The second position is located within the second non-operation area 13. The first support angle can be larger than the second support angle.

Thus, when the second support member 22 abuts against the second non-operation area 13 of the first body 1, the second support angle can be configured as an acute angle. Thus, the electronic device 3 can be placed at the operation platform in the second support attitude having an angle with the horizontal surface being an acute angle. Therefore, the user can input data to the electronic device 3 through the operation area 11 of the first body 1. For example, as shown in FIG. 4, when the first body 1 is configured as the keyboard, and the second support member 22 abuts against at the second non-operation area 13 of the first body 1, the user can operate and use the keyboard to input data to the electronic device 3, i.e., realizing the office mode.

In some embodiments, the second position can be located at different positions within the second non-operation area 13. When the second position is adjusted, the first support member 21 and the second support member 22 can be correspondingly adjusted to form the second support angle snapping toward the first body 1. The second support angle can reduce as the second position within the second non-operation area 13 moves away from the operation area 11.

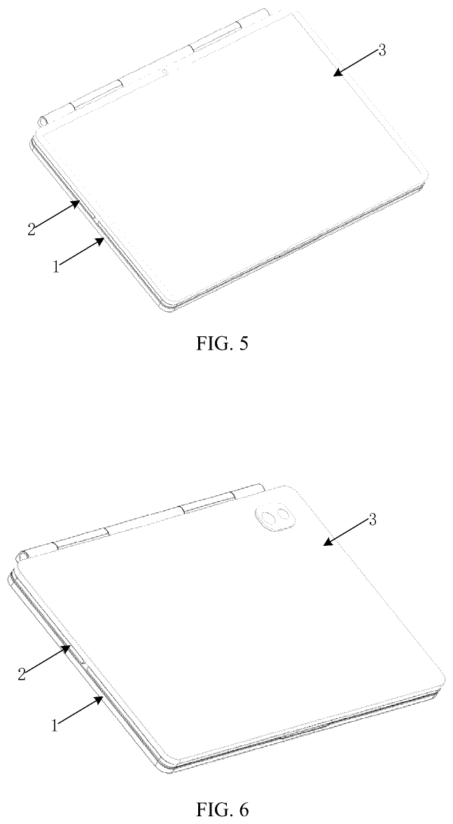

In some embodiments, as shown in FIG. 5 and FIG. 6, the second support member 22 is also able to cooperate with the first support member 21 to be attached to the first body 1. Surfaces of the first support member 21 and the second support member 22 away from the first body 1 can cooperate to form a carrier surface. Thus, the first support member 21 and the second support member 22 can be in the second attitude of being attached to the first body 1 to accommodate and carry the electronic device 3.

Thus, after the first body 1 is attached to the second body 2, the electronic device 3 can be placed at the second body 2. Thus, the auxiliary apparatus of the electronic device 3 can accommodate the electronic device 3.

In some embodiments, the electronic device 3 can be in the second attitude when the first support member 21 and the second support member 22 are in the second attitude. The display area of the electronic device 3 can face outwardly. The user can touch the electronic device 3 to realize the functions, such as writing, drawing, and office work. In some other embodiments, the display area of the electronic device 3 can be arranged facing the second body 2. That is, the display area of the electronic device 3 facing inwardly to protect the display area. Thus, the electronic device 3 can be better accommodated and saved. As shown in FIG. 5, the display area of the electronic device 3 is arranged facing outward. As shown in FIG. 6, the display area of the electronic device 3 is arranged facing inward.

In some embodiments, an outer contour of the carrier surface formed by the cooperation of the first support member 21 and the second support member 22 can match the outer contour of the electronic device 3 to better carry the electronic device 3.

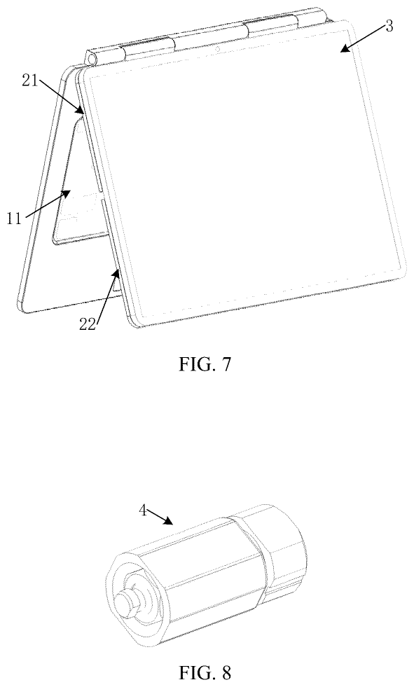

In some embodiments, as shown in FIG. 7, the first support member 21 and the second support member 22 can also cooperate to form a flat first standing surface. An end of the first body 1 that is away from the rotation of the first body 1 and the second body 2 can stand upright and form an angle with the first standing surface. Thus, the first support member 21, the second support member 22, and the first body 1 can cooperate to form the third attitude to provide the third support attitude for the electronic device 3 carried at the first standing surface.

Thus, after the first support member 21, the second support member 22, and the first body 1 cooperate to form the third attitude, the electronic device 3 can be placed at the second body 2. Thus, the electronic device 3 can be caused to be in the third support attitude through the auxiliary apparatus of the electronic device. That is, the electronic device 3 can stand upright. When the electronic device 3 is in the third support attitude, the user can easily watch the display content displayed in the display area of the electronic device 3. Then, the electronic device 3 can be configured to display pictures or videos, which can be referred to as a viewing mode.

In some embodiments, the first standing surface and the plane where the first body 1 is located can be inclined relative to the horizontal plane. The third attitude formed by the cooperation of the first support member 21, the second support member 22, and the first body 1 can stably support the electronic device 3.

In some embodiments, an end of the second support member 22, which is away from the first support member 21, can be configured as an end abutting against the operation platform. A friction member can be arranged at the end to increase the friction between the second support member 22 and the operation platform to stably support the electronic device 3.

In some embodiments, a first position-limiting structure can be arranged at the second support member 22 to limit the position of the electronic device 3. The electronic device 3 can be stably installed through the first position-limiting structure to increase the stability of the support force provided by the auxiliary apparatus of the electronic device to the electronic device 3.

In some embodiments, the first position-limiting structure can at least include one or more of a magnetic structure, a snapping structure, or a support structure.

For example, when the first position-limiting structure includes the magnetic structure, e.g., at least a first magnetic component. A second magnetic component attracted to the first magnetic component can be arranged in the electronic device 3. In some embodiments, two first magnetic components can be provided. Magnetic properties of the two first magnetic components toward the outside can be opposite to each other.

For example, when the first position-limiting structure includes the snapping structure, e.g., at least includes a first snapping component, the electronic device 3 can include a second snapping component being snapped with the first snapping component. Through the first snapping component and the second snapping component, the electronic device 3 can be stably arranged at the second support member 22.

In some embodiments, at least a second position-limiting structure configured to limit the position of the electronic device 3 can be arranged in the second non-operation area 13 of the first body 1. The electronic device 3 can stably remain in the corresponding second support attitude.

In some embodiments, the first support member 21 and the second support member 22 can be also configured to cooperate and form the accommodation chamber with the first body 1. The accommodation chamber can be configured to accommodate the electronic device 3. Thus, the electronic device 3 can be arranged between the first body 1 and the second body 2 to protect and store the electronic device 3.

In some embodiments, the first rotation shaft structure 4 can be lifted to a predetermined height relative to the first body 1. Thus, after the second body 2 is rotated to the direction facing the first body 1, the accommodation chamber can be formed between the first body 1 and the second body 2 to accommodate the electronic device 3.

In some embodiments, the auxiliary apparatus of the electronic device can further include a protection structure. The protection structure can include a connector that is flexibly connected, and the cover plate. The connector can be configured to connect to the first body 1. The cover plate can be configured to cover the electronic device 3 when the first body 1, the second body 2, and the electronic device 3 are attached with each other.

In some embodiments, a fifth magnetic member can be arranged inside the connector. A sixth magnetic member attracted to the fifth magnetic member can be arranged inside the first body 1 to realize the magnetic connection between the connector and the first body 1.

Embodiments of the present disclosure further provide a system of electronic devices. As shown in FIG. 1 to FIG. 7, the system includes the electronic device 3 and the auxiliary apparatus of the electronic device 3. The auxiliary apparatus of the electronic device 3 can carry the electronic device 3.

In the present disclosure, through the first body 1 and the second body 2 that are rotatably connected, and the first support member 21 and the second support member 22 of the second body 2 that are rotatably connected, the second support member 22 can rotate in the direction facing the first body 1 to abut against the first body 1. Thus, the first support member 21 and the second support member 22 can snap at the first body 1 and support the electronic device in the first attitude. The user can perform the operation conveniently. A stable support force can be provided to the electronic device 3. Thus, the display area of the electronic device 3 can match the sight of the user when being supported by the second support member 22, which increases the comfort of the user when using the electronic device 3. Moreover, the auxiliary apparatus of the electronic device can have a simple structure, which is easy to carry and move to realize a plurality of user modes.

Furthermore, although exemplary embodiments have been described herein, the scope includes any and all embodiments with equivalent elements, modifications, omissions, combinations (e.g., cross-combinations of various embodiments), adaptations, or alterations based on the present disclosure. The elements in the claims should be interpreted broadly according to the language used in the claims and are not limited to the examples described in the specification or during the application process. These examples should be interpreted as non-exclusive.

The above description is intended to be illustrative, not limiting. For example, the described examples (or one or more of their variations) can be used in combination with each other. Those skilled in the art can use other embodiments when reading the above description. In addition, in embodiments of the present disclosure, various features can be divided into groups to simplify the present disclosure. The features should not be interpreted as an indication that the disclosed feature is necessary for any one claim. On the contrary, the subject matter of the present disclosure can be less than all features of embodiments of the present disclosure. Thus, the following claims can be used as examples or embodiments and incorporated into specific embodiments. Each claim can be used as an individual embodiment. These embodiments can be grouped with various combinations or arrangements. The scope of the present disclosure should be subjected to the claims and the scope of equivalents of the claims.

The above embodiments are exemplary embodiments of the present disclosure and are not used to limit the present disclosure. The scope of the present disclosure is subject to the claims. Those skilled in the art can make various modifications or equivalent replacements to the present disclosure within the essence and scope of the present disclosure. These modifications and equivalent replacements should be within the scope of the present disclosure.

What is claimed is:

1. An auxiliary apparatus for an electronic device comprising:
a first body;
a second body including a first support member and a second support member rotatably connected to each other, the first support member being rotatably connected to the first body, and the second support member being able to rotate in a direction facing the first body to abut against the first body to allow the first support member and the second support member to be in a first attitude snapping toward the first body to support the electronic device carried by the second support member.

2. The auxiliary apparatus according to claim 1, wherein:
a surface of the second support member facing away from the first body is configured as a support surface to carry the electronic device;
in the first attitude, the first support member and the second support member form a first support angle and a second support angle snapping toward the first body;
under the first support angle, the second support member abuts against the first body at a first position;
under the second support angle, the second support member abuts against the first body at a second position; and
a first support attitude and a second support attitude are provided to the carried electronic device corresponding to the first support angle and the second support angle, respectively, the first support attitude being different the second support attitude.

3. The auxiliary apparatus according to claim 2, wherein:
the first body includes an operation area and a first non-operation area;
the first non-operation area is further away from a connection between the first body and the second body compared to the operation area; and
the first position is in the first non-operation area.

4. The auxiliary apparatus according to claim 2, wherein:
the first body includes an operation area and a second non-operation area;
the second non-operation area is closer to a connection between the first body and the second body compared to the operation area;
the second position is in the second non-operation area; and
the first support angle is greater than the second support angle.

5. The auxiliary apparatus according to claim 1, wherein:
the second support member cooperates with the first support member to be attached to the first body;
surfaces of the first support member and the second support member facing away from the first body cooperate to form a carrier surface to allow the first support member and the second support member to form the second attitude attaching to the first body to accommodate the carried electronic device.

6. The auxiliary apparatus according to claim 1, wherein:
the first support member and the second support member cooperate to form a flat first standing surface; and
an end of the first body away from a rotatable connection between the first body and the second body is able to stand upright and form an angle with the first standing surface to allow the first support member, the second support member, and the first body to form a third attitude to provide a third support attitude for the electronic device carried by the first standing surface.

7. The auxiliary apparatus according to claim 1, wherein the second support member includes a first position-limiting structure configured to limit a position of the electronic device.

8. The auxiliary apparatus according to claim 4, wherein the second non-operation area of the first body includes at least one second position-limiting structure configured to limit a position of the electronic device.

9. The auxiliary apparatus according to claim 1, wherein:
the first support member and the second support member are configured to cooperate to form an accommodation chamber with the first body; and
the accommodation chamber is configured to accommodate the electronic device to allow the first support member, the second support member, and the first body to cooperate to form a fourth attitude to accommodate the electronic device.

10. A system of electronic devices, comprising:
an electronic device; and
an auxiliary apparatus for the electronic device configured to carry the electronic device and including:
a first body; and
a second body including a first support member and a second support member rotatably connected to each other, the first support member being rotatably connected to the first body, and the second support member being able to rotate in a direction facing the first body to abut against the first body to allow the first support member and the second support member to be in a first attitude snapping toward the first body to support the electronic device carried by the second support member.

11. The system according to claim 10, wherein:
a surface of the second support member facing away from the first body is configured as a support surface to carry the electronic device;
in the first attitude, the first support member and the second support member form a first support angle and a second support angle snapping toward the first body;
under the first support angle, the second support member abuts against the first body at a first position;
under the second support angle, the second support member abuts against the first body at a second position; and
a first support attitude and a second support attitude are provided to the carried electronic device corresponding to the first support angle and the second support angle, respectively, the first support attitude being different the second support attitude.

12. The system according to claim 11, wherein:
the first body includes an operation area and a first non-operation area;
the first non-operation area is further away from a connection between the first body and the second body compared to the operation area; and
the first position is in the first non-operation area.

13. The system according to claim 11, wherein:
the first body includes an operation area and a second non-operation area;
the second non-operation area is closer to a connection between the first body and the second body compared to the operation area;
the second position is in the second non-operation area; and
the first support angle is greater than the second support angle.

14. The system according to claim 10, wherein:
the second support member cooperates with the first support member to be attached to the first body;
surfaces of the first support member and the second support member facing away from the first body cooperate to form a carrier surface to allow the first support member and the second support member to form the second attitude attaching to the first body to accommodate the carried electronic device.

15. The system according to claim 10, wherein:
the first support member and the second support member cooperate to form a flat first standing surface; and
an end of the first body away from a rotatable connection between the first body and the second body is able to stand upright and form an angle with the first standing surface to allow the first support member, the second support member, and the first body to form a third attitude to provide a third support attitude for the electronic device carried by the first standing surface.

16. The system according to claim 10, wherein the second support member includes a first position-limiting structure configured to limit a position of the electronic device.

17. The system according to claim 13, wherein the second non-operation area of the first body includes at least one second position-limiting structure configured to limit a position of the electronic device.

18. The system according to claim 10, wherein:
the first support member and the second support member are configured to cooperate to form an accommodation chamber with the first body; and
the accommodation chamber is configured to accommodate the electronic device to allow the first support member, the second support member, and the first body to cooperate to form a fourth attitude to accommodate the electronic device.
